(19) United States
(12) Patent Application Publication
(10) Pub. No.: US 2002/0042752 A1
(43) Pub. Date: Apr. 11, 2002

(54) Internet motor vehicle sales

(76) Inventor: Jimmy Bernard Chaves, Toronto (CA)

Correspondence Address: JIMMY BERNARD CHAVES, 11 WINCREST DRIVE, TORONTO, ON, M1P4J3, CA

(21) Appl. No.: 09/920,864

(22) Filed: Aug. 3, 2001

Related U.S. Application Data
(60) Provisional application No. 60/222,976, filed on Aug. 4, 2000.

(51) Int. Cl. G06F 17/60

(52) U.S. Cl. 705/26

(57) ABSTRACT

This invention utilizes information technology to a degree not previously employed in the sales of motor vehicles and related products and services, providing customers with a high level of functionality, pertinent information, choices and control over the process, while delivering operating efficiencies and streamlined processes to dealers and manufacturers.

### BACKGROUND OF THE INVENTION

This invention will permit motor vehicle dealers to provide fully functional, remote electronic commerce services to their customers via the internet or other appropriate electronic medium. Within this remote, on-line and fully-automated framework, dealers will provide: 1) fixed-price sales and negotiation-based trade-ins; 2) interactive negotiation-based selling and trading-in; and 3) facilities for shoppers to submit fully-committed and time-specified bids (to purchase) and asks (to trade-in) into a host (electronic) environment for viewing and possible acceptance by dealer(s). These (3) methods will see dealer prices float freely while impacted by supply and demand, season, weather conditions, model year, name plate, individual business strategy, or any other reasonable condition or preference. Also within this framework, shoppers can select and view audiovisual demonstrations of vehicles, search inventory and custom-build vehicles, submit bids with the required deposit (credit/debit card or electronic funds transfer) and instantly obtain financing. Customers may also elect to have their purchases delivered to a location of their choice.

These functions will provide dealerships with comprehensive, end-to-end e-commerce solutions that are being demanded by an ever-increasing segment of the population. When combined with the current face-to-face model, these facilities will allow dealerships to solidify and enhance their role in the industry, while maintaining the necessary competitive environment from which consumers gain the most benefit. The advanced technologies will reduce administrative and selling costs, while providing efficiencies in many other areas, benefiting manufacturers, dealers and consumers.

The PTO classification is #705, Data processing: Financial, Business Practice, Management, or Cost/Price Determination. The subclass is #26, Electronic Shopping.

### BRIEF SUMMARY OF THE INVENTION

The Invention Consists of:

Knowledge bases containing all the required information to allow customers to make informed decisions on the purchase of vehicles, parts, accessories and services;

Database(s), available to customers that consists of all new and used vehicles, spare parts and accessories available for sale by dealers;

Virtual showrooms for purchasers to roam as they view and examine vehicles, features and options;

Software tools that allow purchasers to virtually custom-build vehicles on-line;

Intelligent, price-adjusting software that utilize current information from always-on interface with both macro and micro views of the industry and dealership as well as weather and economic conditions;

Software that allows remote shoppers to interact in real time with dealer's fully automated, fully informed, intelligent and decision-making systems that utilize highly relevant information such as: 1) the sequence of a bid; 2) the amount (currency) of a bid in relationship to the ‘MSRP’, ‘Dealer Cost’ and ‘Dealer established Target Price’; 3) the inclusion of a trade-in and it's value to the Dealer; and other pertinent data.

Internet/online banking facilities such as electronic funds transfer, credit or debit card, or other similar method of payment that will allow customers to transfer/submit funds with their offers to the dealers;

Virtual Private Network, Internet Service Provider, Application Service Provider, Storage Utility and Network facilities to allow for highly accessible, toll free connections between customers, dealers, manufacturers and other relevant business partners;

Server side computer hardware and software to accommodate programs, graphics and data and facilitate functions, as well as client side Personal Computers (PC), Personal Digital Assistants (PDA), Telephones (wireline and wireless), Interactive TV sets and other Digital Devices;

Call centers to assist customers when needed.

This Invention Allows Customers:

To remain in the relative comfort and safety of the home, office, or other indoor facility as he/she visits any number of dealerships in virtual reality, any distance away, 24 hours a day, 365 days a year, in any type of weather conditions;

Quick and easy access to vast amounts of technical and other pertinent data/documentation (on-line), thereby allowing for more informed and rational decisions regarding their purchases;

Access to a broad and deep selection of vehicles and related items which can be viewed and examined in a very narrow window of time through virtual reality tours of the dealers' inventories;

Who may be uncomfortable with the face-to-face dealing and lengthy sessions of negotiation with highly skilled salespersons and managers, to effectively complete end-to-end electronic purchases and related transactions thus providing more gratifying and time-efficient experiences.

The objective of the invention is to provide the motor vehicle industry with state-of-the-art technology for interaction with end users that choose, for varying reasons, to communicate electronically when dealing with industry representatives, thus enhancing the experience for both seller and buyer.

### BRIEF DESCRIPTION OF THE SEVERAL VIEWS OF THE DRAWING

Not Applicable

### DETAILED DESCRIPTION OF THE INVENTION

The invention will permit the Dealers to provide electronic-based remote sales and related communication (e-commerce) for customers as an option to the traditional face-to-face method, while effectively managing pricing policy by establishing ‘Dealer target Prices’ for all vehicles, either individually or by groups. The highly intelligent, automated system will then continuously manage all related processes to ensure that overall target levels are consistently achieved. Participating dealers' systems (inventory, financial, sales, service and customer records) will interface electronically in real time processing mode or be synchronize with the ‘Motor Vehicle Dealer e-tailing’ system (the ‘Invention’) as required, in order to fully enable remote, electronic sales and service. The system (‘Invention’) will also interface electronically in real time processing mode, with selected Financial Institutions (lenders, deposit, credit/debit card and insurance) as well as Credit Reporting and Credit Evaluating and Approving facilities. The system will contain links to the participating Manufacturers' web sites.

The shopper will access the ‘Motor Vehicle Dealer e-tailing’ system (Invention) website which will be the ‘Portal’ or ‘Launch Pad’ as well as the e-commerce site. He/she may elect to research a vehicle(s) using the information provided by the manufacturer(s) in which case he/she will click on the link provided at the ‘Portal’, do the research, then return to the ‘Portal’. He/she may (also) choose to do research at a web facility provided by some level of Government or other independent/non-affiliated site. Most of the reputable sites can also be accessed from the ‘Portal’.

Shoppers must provide: 1) the personal information requested; 2) the method and details of payment; and 3) a user name and password in order to gain access to all the functions required for a complete shopping experience. The requested information will be used to establish an account for the user that will permit instant future access (user name and password only) as well as provide instant payment, delivery instructions and checkout. If the shopper does not provide the requested information, or the payment information cannot be authenticated, access will not be allowed beyond the point of request.

Upon completion of the research, or if research is not required, the shopper then utilizes the numerous search tools available for locating vehicles, parts, accessories, service, etc. Inventory includes new vehicles at the manufacturing stage and in transit, as well as used vehicles inbound (traded-in or otherwise purchased but not yet received at the dealer's lot).

If unable to locate a suitable (new vehicle) choice from dealers' inventories, the shopper may elect to access the related manufacturer's web site where he/she will be provided the tools to readily enable him/her to virtually custom-build a vehicle to be ordered from the factory. The specifications are then conveyed to the portal where the process is continued with the selected dealer.

Once a selection is made, the shopper is provided a partially-completed, on-line Bill-of-Sale or Lease Agreement with the full description of the vehicle including the manufacturer's suggested retail price for a new vehicle or the dealer's list price for used. The shopper is then required to select one of the following formats:

Purchase vehicle with down-payment of $_+_without trade-in;

Show approximate monthly payments for #_+_month term

Lease vehicle with down-payment of $_+_without trade-in for #_+_ months;

Standard mileage allowance #_*_; Cash Back $_*_{—}

Non-standard mileage allowance #_+_; Cash Back $_*_{—}

Standard mileage allowance #_*_; Optional Buy-Back $_*_{—}

Non-standard mileage allowance #_+_; Optional Buy-Back $_*_{—}

Lessee's Guarantee of Residual/Purchase $*_*_ (normal use)

Lessee's Guarantee of Residual/Purchase $_+_ (additional use) (minimum is value for normal use)

Purchase vehicle with down-payment of $_+_ and include trade-in as a combined transaction only (net-price);

Show approximate monthly payments for #_+_ month term

Lease vehicle with down-payment of $_+_ and include trade-in as a combined transaction only (net price) for #_+_ months;

Standard mileage allowance #_*_; Cash Back $_*_{—}

Non-standard mileage allowance #_+_; Cash Back $_*_{—}

Standard mileage allowance #_*_; Optional Buy-Back $_*_{—}

Non-standard mileage allowance #_+_; Optional Buy-Back $_*_{—}

Lessee's Guarantee of Residual/Purchase $_*_ (normal use)

Lessee's Guarantee of Residual/Purchase $_+_ (additional use) (minimum is value for normal use)

* system generated

+ inserted by shopper

N.B. Non-standard mileage allowance (minimum is standard allowance)-If the shopper selects an option with this clause, the Residual value is adjusted as follows:

Non-standard allowance #_{—}

Less standard allowance #_{—}

Sub-total #_{—}

times (×) dealer inserted cost per additional mile/km $_{—}

Residual reduced by $_{—}

If the shopper selects an option that includes a ‘trade-in’, the trade-in section of the document is highlighted and he/she is requested to provide details of the trade including any outstanding liens and the amount(s). Users can also access the site for the sole purpose of selling/trading-in vehicles to dealers. The user then selects the year, make, model, engine and transmission specifications, and optional equipment, then records the color (interior and exterior) and inserts the odometer reading and their Postal/Zip code. The shopper is next provided with a ‘virtual walkaround’ checklist that allows him/her to rate the condition of various components/areas of the vehicle from which an overall rating and consequently the trade-in/wholesale value is derived.

Acquire Vehicle Without a Trade-in

The shopper either:

a) clicks on the ‘BUY’ or ‘LEASE’ button to acquire the vehicle at the dealer's fixed price if a ‘Fixed Price’ is displayed. The required deposit is immediately processed and if approved, binds the deal conditional only on financing.

### OR

b) inserts a bid amount (total price for a purchase; monthly payment for a lease) and clicks on the ‘BID’ button. The shopper may submit a blank bid initially, in order to have the system begin the process by asking a price. The system either accepts the shopper's bid or responds by asking a different price. The shopper has the option of either accepting the system's asking price or rejecting it and submitting another bid. The process could conceivably be repeated numerous times until either: 1) the system accepts the shopper's bid; or 2) the shopper accepts the system's asking price; or 3) the system indicates to the shopper that the final asking price is being displayed wherein the shopper either accepts or rejects this final asking price. Upon acceptance of either a bid by the system or ask by the shopper, the required deposit is immediately processed and if approved, binds the deal conditional only on financing. If the two sides (dealer and shopper) are unable to consummate a deal, the shopper is requested to submit his/her final Bid (offer) to the Electronic Host System in accordance with \mathring{c} below. If the dealer's final ask is rejected by the shopper, the session is terminated.

If the shopper initially submits a blank bid, the system responds with the MSRP (new) or Dealer List Price (used) for a sale, or a lease price based on the MSRP/Dealer List Price as the capitalized cost. The shopper either accepts the asked price or submits a bid price of his/her own. The system configures/calculates the responses to the shopper's bids in accordance with the following algorithms:

Response to 1^{st} Bid

Accepted if the bid meets or exceeds the mid-point between the target price and the MSRP/Dealer List Price for a Purchase. The Bid for a Lease Payment must meet or exceed the payment calculation based on the capital cost of ‘the mid-point between the Target Price and MSRP/Dealer List Price

### Otherwise

Calculates and asks a different price for a Purchase based on the following:

$_ Bid Price

$_ (+) Difference between Target and Bid Price

$_ (+) 4% of Target Price

$_ (sum total) Asking Price

Calculates and asks a different price for a Lease Payment based on the following:

$_ Bid Price (i.e. monthly payment) *reverse converted to the capital cost ($)

*payment amount ×# of payments +residual value −(minus) costs [interest, administration, other]

$_ (+) Difference between Target and Bid Price

$_ (+) 4% of Target Price

$_ (sum total) Capital cost for use in calculating payment below

$_ Asking Price (i.e. monthly payment)

Response to 2^{nd} Bid

Accepted if the bid meets or exceeds the mid-point between the target price and the mid-point referred to in the ‘Response to 1^{st} Bid’ for a Purchase. The Bid for a Lease Payment must meet or exceed the payment calculation based on the capital cost of “the mid-point between the Target Price and the 1^{st} mid-point”

### Otherwise

Calculates and asks a different price for a Purchase based on the following:

$_{—} 2^{nd} Bid Price

$_ (+) Difference between Target and 2^{nd} Bid Price

$_ (+) 3.5% of Target Price

$_ (sum total) Asking Price

Calculates and asks a different price for a Lease Payment based on the following:

$_{—} 2^{nd} Bid Price (i.e. monthly payment) *reverse converted to the capital cost ($)

$_ (+) Difference between Target and 2^{nd} Bid Price

$_ (+) 3.5% of Target Price

$_ (sum total) Capital cost for use in calculating payment below

$_ Asking Price (i.e. monthly payment)

Response to 3^{rd} Bid

Calculates and asks a different price for a Purchase based on the following:

$_{—} 3^{rd} Bid Price

$_ (+) Difference between Target and 3^{rd} Bid Price

$_ (+) 3% of Target Price

$_ (sum total) Asking Price

Calculates and asks a different price for a Lease Payment based on the following:

$₁₃ 3^{rd} Bid Price (i.e. monthly payment) *reverse converted to the capital cost ($)

$_ (+) Difference between Target and 3^{rd} Bid Price

$_ (+) 3% of Target Price

$_ (sum total) Capital cost for use in calculating payment below

$_ Asking Price (i.e. monthly payment)

Response to 4^{th} Bid

Calculates and asks a different price for a Purchase based on the following:

$_{—} 4^{th} Bid Price

$_ (+) Difference between Target and 4^{th} Bid Price

$_ (+) **2.5% of Target Price

$_ (sum total) Asking Price

Calculates and asks a different price for a Lease Payment based on the following:

$_{—} 4^{th} Bid Price (i.e. monthly payment) *reverse converted to the capital cost ($)

$_ (+) Difference between Target and 4^{th} Bid Price

$_ (+) **2.5% of Target Price

$_ (sum total) Capital cost for use in calculating payment below

$_ Asking Price (i.e. monthly payment)

Response to 5^{th} Bid

If the 4^{th} Asking Price for a Purchase exceeds the shopper's 5^{th} Bid by more than the **(x% of Target Price) amount, then the next Asking Price (5^{th}) becomes the final one for the session and is the lesser of either a) or b) below:

a) the 4^{th} Asking Price;

### or

b) $_ Target Price

$_ (+) ½ of the difference between the Target and the 5^{th} Bid

$_ (sum total) Asking Price

However, if the 4^{th} Asking Price for a Purchase does not exceed the shopper's 5^{th} Bid by more than the **(x% of Target Price) amount, then the system selects the final Asking Price (5^{th}) from the higher of the Shopper's 5^{th} Bid or the Target Price.

If the 4^{th} Asking Price (reverse converted to capital cost) for a Lease Payment exceeds the shopper's 5^{th} Bid (reverse converted) by more than the **(x% of Target Price) amount, then the next Asking Price (5^{th}) becomes the final one for the session and is the lesser of either a) or b) below:

a) the 4^{th} Asking Price;

### or

b) $_ Target Price

$_ (+) ½ of the difference between the Target and the [5^{th} Bid reverse converted ($)]

$_ (sum total) Capital cost for use in calculating payment below

$_ Asking Price (i.e. monthly payment)

However, if the 4^{th} Asking Price (reverse converted) for a Lease Payment does not exceed the shopper's 5^{th} Bid (reverse converted) by more than the **(x% of Target Price) amount, then the system selects the final Asking Price (5^{th}) from the higher of the Shopper's 5^{th} Bid or payment based on Target Price as the capital cost.

### OR

c) inserts a bid amount (total price for a purchase; monthly payment for a lease) and expiry date (of the bid) into the (electronic) mobile agent/representative and clicks on the submit button to send the bid to an electronic host environment where it will reside awaiting acceptance or termination. Bids must conform to minimum requirements and specifications in order to be accepted by the host. The system response is “Thank you for your Bid. The bid will be placed in the Host Reservoir and held along with others awaiting Dealer's acceptance, Shopper's amendment or natural termination. You will be notified by e-mail when a change in status occurs. Please check your mailbox regularly for updates.”

The dealer (or dealers to whom the bid was directed) will be instantly notified of all new incoming or amended bids and have ongoing access to those outstanding for their stores (only). Bids are either: 1) accepted by the dealer as submitted; or 2) revised, extended or cancelled by the bidder/shopper prior to dealer's acceptance; or 3) terminated upon: a) expiry; or b) disposal of the vehicle by the originally specified dealer (inventory); or c) build out—the manufacturer no longer accepting orders for the specified year and model (factory order); or d) subsequent acquisition of another vehicle through this portal from any of the associated dealers (post-acceptance/pre-financing). Upon acceptance by the dealer, the required deposit is immediately processed and if approved, binds the deal conditional only on financing.

Acquire and Trade-in Vehicles Simultaneously

The shopper either:

a) clicks on the ‘BUY’ or ‘LEASE’ button to acquire the vehicle at the dealer's fixed price if a ‘Fixed Price’ is displayed. The system responds with the Net Asking Price (fixed price less the value of the trade) the shopper has the option of accepting it, or rejecting it and submitting a Net Bid Price. The process could conceivably be repeated numerous times until either: 1) the system/dealer accepts the shopper's Net Bid Price; or 2) the shopper accepts the system's/dealer's Net Asking Price; or 3) the system indicates to the shopper that the final dealer's Net Asking Price is being displayed and the shopper either accepts or rejects this final Net Asking Price. Upon acceptance, the required deposit is immediately processed and if approved, binds the deal conditional only on financing. If the dealer's final net ask is rejected by the shopper, the session is terminated.

Response to 1^{st} Bid

The higher of 1) or 2) below for a Purchase:

1) 1^{st} Net Bid

2) 1^{st} Net Asking Price (−) minus 5% of the difference between the [wholesale and retail value of the trade]

The higher of 1) or 2) below for a Lease Payment:

1) 1^{st} Net Bid

2) 1^{st} Net Asking Price reverse converted to capital cost (−) minus 5% of the difference between the [wholesale and retail value of the trade]. The result used as the capital cost for calculating the new Net Asking Price (i.e. monthly payment)

Response to 2^{nd} Bid and dealer's final ‘Net Asking Price’

The higher of 1) or 2) below for a Purchase:

1) 2^{nd} Net Bid

2) 1^{st} Net Asking Price (−) minus 10% of the difference between the [wholesale and retail value of the trade]

The higher of 1) or 2) below for a Lease Payment:

1) 2^{nd} Net Bid

2) 1^{st} Net Asking Price reverse converted to capital cost (−) minus 10% of the difference between the [wholesale and retail value of the trade]. The result used as the capital cost for calculating the new Net Asking Price (i.e. monthly payment)

### OR

b) inserts a net bid amount (total price for a purchase or monthly payment for a lease) after accounting for the net valuation of the trade-in and clicks on the ‘NET BID’ button. The shopper may submit a blank bid initially, in order to have the system begin the process by asking a price. The system either accepts the shopper's net bid or responds by asking a different net price. The shopper has the option of either accepting the system's net asking price or rejecting it and submitting a different net bid. The process could conceivably be repeated numerous times until either: 1) the system accepts the shopper's net bid; or 2) the shopper accepts the system's net asking price; or 3) the system indicates to the shopper that the final net asking price is being displayed wherein the shopper either accepts or rejects this final net asking price. Upon acceptance of either a net bid by the system or a net asking price by the shopper, the required deposit is immediately processed and if approved, binds the deal conditional only on financing. If the two sides (dealer and shopper) are unable to consummate a deal, the shopper is requested to submit his/her final Bid (offer) to the Electronic Host System in accordance with \mathring{e} below. If the dealer's final net ask is rejected by the shopper, the session is terminated.

If the shopper initially submits a blank bid, the system responds with the MSRP/List minus the wholesale/trade-in value of the proposed trade for a sale, or a lease price based on the MSRP/List minus the wholesale/trade-in value as the capitalized cost. The shopper either accepts the net price asked or submits a net bid price of his/her own. The system configures/calculates the responses to the shopper's bids in accordance with the following algorithms:

Response to 1^{st} Bid

Accepted if the net bid meets or exceeds the mid-point between the target price and the MSRP/List minus the net value of the trade for a Purchase. The Net Bid for a Lease Payment must meet or exceed the payment calculation based on a capital cost of ‘the mid-point between the Target Price and MSRP/List minus the net value of the trade’

### Otherwise

Calculates and asks a different net price for a Purchase based on the following:

$_ Net Bid Price plus (+) net wholesale/trade-in value

$_ (+) Target price minus (−) the sum of [the Net Bid Price and net wholesale/trade-in value]

$_ (+) 4% of Target Price

$_ (−) net wholesale/trade-in value

$_ (sum total) Net Asking Price

Calculates and asks a different price for a Net Lease Payment based on the following:

$_ Net Bid Price (i.e. monthly payment) *reverse converted to a capital cost ($) value, plus (+) net wholesale/trade-in value.

*payment amount ×# of payments +residual value minus (−) costs [interest, administration, other]

$_ (+) Target Price minus (−) the sum of [the Net Bid Price reverse converted to a capital cost ($) value plus the net wholesale/trade-in value]

$_ (+) 4% of Target Price

$_ (−) net wholesale/trade-in value

$_ (sum) Total is Capital cost for use in calculating payment below

$_ Net Asking Price (i.e. monthly payment)

Response to 2^{nd} Bid

Accepted if the net bid meets or exceeds the mid-point between the target price and the mid-point referred to in the ‘Response to 1^{st} Bid’ minus the net value of the trade, for a Purchase. The Net Bid for a Lease Payment must meet or exceed the payment calculation based on a capital cost of “the mid-point between the Target Price and the mid-point referred to in the ‘response to 1^{st} bid’ minus the net value of the trade.”

### Otherwise

Calculates and asks a different net price for a Purchase based on the following:

$_{—} 2^{nd} Net Bid Price plus (+) net wholesale/trade-in value

$_ (+) Target price minus (−) the sum of [the 2^{nd} Net Bid Price and net wholesale/trade-in value]

$_ (+) 3.5% of Target Price

$_ (−) net wholesale/trade-in value

$_ (sum total) Net Asking Price

Calculates and asks a different price for a Net Lease Payment based on the following:

$_{—} 2^{nd} Net Bid Price (i.e. monthly payment) *reverse converted to a capital cost ($) value, plus (+) net wholesale/trade-in value.

*payment amount ×# of payments +residual value minus (−) costs [interest, administration, other]

$_ (+) Target Price minus (−) the sum of [the 2^{nd} Net Bid Price reverse converted to a capital cost ($) value plus the net wholesale/trade-in value]

$_ (+) 3.5% of Target Price

$_ (−) net wholesale/trade-in value

$_ (sum) Total is Capital cost for use in calculating payment below

$_ Net Asking Price (i.e. monthly payment)

Response to 3^{rd} Bid

Calculates and asks a different net price for a Purchase based on the following:

$_{—} 3rd Net Bid Price plus (+) net wholesale/trade-in value

$_ (+) Target price minus (−) the sum of [the 3rd Net Bid Price and net wholesale/trade-in value]

$_ (+) 3% of Target Price

$_ (−) net wholesale/trade-in value

$_ (sum total) Net Asking Price

Calculates and asks a different price for a Net Lease Payment based on the following:

$_{—} 3rd Net Bid Price (i.e. monthly payment) *reverse converted to a capital cost ($) value, plus (+) net wholesale/trade-in value.

*payment amount ×# of payments +residual value minus (−) costs [interest, administration, other]

$_ (+) Target Price minus (−) the sum of [the 3rd Net Bid Price reverse converted to a capital cost ($) value plus the net wholesale/trade-in value]

$_ (+) 3% of Target Price

$_ (−) net wholesale/trade-in value

$_ (sum) Total is Capital cost for use in calculating payment below

$_ Net Asking Price (i.e. monthly payment)

Response to 4^{th} Bid

Calculates and asks a different net price for a Purchase based on the following:

$_{—} 4th Net Bid Price plus (+) net wholesale/trade-in value

$_ (+) Target price minus (−) the sum of [the 4th Net Bid Price and net wholesale/trade-in value]

$_ (+) **2.5% of Target Price

$_ (−) net wholesale/trade-in value

$_ (sum total) Net Asking Price

Calculates and asks a different price for a Net Lease Payment based on the following:

$_{—} 4th Net Bid Price (i.e. monthly payment) *reverse converted to a capital cost ($) value, plus (+) net wholesale/trade-in value.

*payment amount ×# of payments +residual value minus (−) costs [interest, administration, other]

$_ (+) Target Price minus (−) the sum of [the 4th Net Bid Price reverse converted to a capital cost ($) value plus the net wholesale/trade-in value]

$_ (+) **2.5% of Target Price

$_ (−) net wholesale/trade-in value

$_ (sum) Total is Capital cost for use in calculating payment below

$_ Net Asking Price (i.e. monthly payment)

Response to 5^{th} Bid

If the 4^{th} Net Asking Price for a Purchase exceeds the shopper's 5^{th} Net Bid by more than the **(x% of Target Price) amount, then the next Net Asking Price (5^{th}) is the lesser of either a) or b) below:

a) the 4^{th} Net Asking Price minus 5% of the difference between the [wholesale/trade-in and retail value of the trade]

### or

b)$_ Target Price minus the wholesale/trade-in value

$_ (+) ½ of the difference between the 5^{th} Net Bid and the [Target Price minus (−) the wholesale/trade-in value]

$_ (−) 5% of the difference between the [wholesale/trade-in and retail value of the trade]

$_ (sum total) Net Asking Price

However, if the 4^{th} Net Asking Price for a Purchase does not exceed the shopper's 5^{th} Net Bid by more than the **(x% of Target Price) amount, then the system selects the next Net Asking Price (5^{th}) from the higher of the ‘Shopper's 5^{th} Net Bid’ or, the ‘Target Price minus [the net wholesale/trade-in value plus (+) 5% of the difference between the wholesale/trade-in and retail value of the trade]’.

If the 4^{th} Net Asking Price (reverse converted to capital cost) for a Lease Payment exceeds the shopper's 5^{th} Net Bid (reverse converted) by more than the **(x% of Target Price) amount, then the next Net Asking Price (5^{th}) is the lesser of either a) or b) below:

a) $_{—} 4^{th} Net Asking Price (reverse converted to capital cost)

$_ (−) 5% of the difference between [the wholesale/trade-in and the retail value of the trade]

$_ (sum total) Capital cost for use in calculating payment below

$_ Net Asking Price (i.e. monthly payment)

### or

b) $_ Target Price minus the wholesale/trade-in value

$_ (+) ½ of the difference between the Target and the [5^{th} Net Bid reverse converted ($) plus the wholesale/trade-in value]

$_ (−) 5% of the difference between [the wholesale/trade-in and the retail value of the trade]

$_ (sum total) Capital cost for use in calculating payment below

$_ Asking Price (i.e. monthly payment)

However, if the 4^{th} Net Asking Price (reverse converted) for a Lease Payment does not exceed the shopper's 5^{th} Net Bid (reverse converted) by more than the **(x% of Target Price) amount, then the system selects the next Net Asking Price (5^{th}) from the higher of the ‘5^{th} Net Bid’ or the Net Asking Price below:

$_ Target Price minus the wholesale/trade-in value

$_ (−) 5% of the difference between [the wholesale/trade-in and the retail value of the trade]

$_ (sum total) Capital cost for use in calculating payment below

$_ Net Asking Price (i.e. monthly payment)

Response to 6^{th} Bid

If the 4^{th} Net Asking Price for a Purchase exceeds the shopper's 6^{th} Net Bid by more than the **(x% of Target Price) amount, then the next and final Net Asking Price (6^{th}) is the lesser of either a) or b) below:

a) the 4^{th} Net Asking Price minus 10% of the difference between the [wholesale/trade-in and retail value of the trade]

### or

b) $_ Target Price minus the wholesale/ trade-in value

$_ (+) ½ of the difference between the 6^{th} Net Bid and the [Target Price minus (−) the wholesale/trade-in value]

$_ (−) 10% of the difference between the [wholesale/trade-in and retail value of the trade]

$_ (sum total) Net Asking Price

However, if the 4^{th} Net Asking Price for a Purchase does not exceed the shopper's 6^{th} Net Bid by more than the **(x% of Target Price) amount, then the system selects the next and final Net Asking Price (6^{th}) from the higher of the ‘Shopper's 6^{th} Net Bid’ or the ‘Target Price minus [the net wholesale/trade-in value plus (+) 10% of the difference between the wholesale/trade-in and retail value of the trade]’.

If the 4^{th} Net Asking Price (reverse converted to capital cost) for a Lease Payment exceeds the shopper's 6^{th} Net Bid (reverse converted) by more than the **(x% of Target Price) amount, then the next and final Net Asking Price (6^{th}) is the lesser of either a) or b) below:

a) $_{—} 4^{th} Net Asking Price (reverse converted to capital cost)

$_ (−) 10% of the difference between [the wholesale/trade-in and the retail value of the trade]

$_ (sum total) Capital cost for use in calculating payment below

$_ Net Asking Price (i.e. monthly payment)

### or

b) $_ Target Price minus the wholesale/trade-in value

$_ (+) ½ of the difference between the Target and the [6^{th} Net Bid reverse converted ($) plus the wholesale/trade-in value]

$_ (−) 10% of the difference between [the wholesale/trade-in and the retail value of the trade]

$_ (sum total) Capital cost for use in calculating payment below

$_ Asking Price (i.e. monthly payment)

However, if the 4^{th} Net Asking Price (reverse converted) for a Lease Payment does not exceed the shopper's 6^{th} Net Bid (reverse converted) by more than the **(x% of Target Price) amount, then the system selects the next and final Net Asking Price (6^{th}) from the higher of the ‘6^{th} Net Bid’ or the Net Asking Price below:

$_ Target Price minus the wholesale/trade-in value

$_ (−) 10% of the difference between [the wholesale/trade-in and the retail value of the trade]

$_ (sum total) Capital cost for use in calculating payment below

$_ Net Asking Price (i.e. monthly payment)

### OR

c) inserts a net bid amount (the total price for a purchase or monthly payment for a lease, after accounting for the net valuation of the trade-in) and expiry date (of the bid) into the (electronic) mobile agent/representative then clicks on the ‘SUBMIT’ button to send the bid to an electronic host environment where it will reside awaiting acceptance or termination. Bids must conform to minimum requirements and specifications in order to be accepted by the host. The dealer or dealers to whom the bid was directed will be instantly notified of the new incoming bids and have ongoing access to those outstanding for their stores (only). Bids are either: 1) accepted by the dealer as submitted; or 2) revised, extended or cancelled by the bidder/shopper prior to dealer's acceptance; or 3) terminated upon: a) expiry; or b) disposal of the vehicle by the originally specified dealer (inventory); or c) build out—the manufacturer no longer accepting orders for the specified year and model (factory order); or d) subsequent acquisition of another vehicle through this portal from any of the associated dealers (post-acceptance/pre-financing). Upon acceptance by the dealer, the required deposit is immediately processed and if approved, binds the deal conditional only on financing.

| | Other % Groups | | | | | | | | |
|---|---|---|---|---|---|---|---|---|---|
| | (selected at random) | | | | | | | | |
| Groups | 1st | 2nd | 3rd | 4th | 5th | 6th | 7th | 8th | 9th |
| Response to 1st Bid % | 4 | 3.8 | 4.2 | 4 | 4 | 3.8 | 3.8 | 4.2 | 4.2 |
| Response to 2nd Bid % | 3.5 | 3.3 | 3.7 | 3.3 | 3.7 | 3.5 | 3.7 | 3.5 | 3.3 |
| Response to 3rd Bid % | 3 | 2.8 | 3.2 | 2.8 | 3.2 | 3 | 3.2 | 3 | 2.8 |
| Response to 4th Bid % | 2.5 | 2.3 | 2.7 | 2.3 | 2.7 | 2.5 | 2.7 | 2.5 | 2.3 |

### Other Parameters or Criteria

Shoppers' Bids below the dealer's cost will generate the following responses:

BID RESPONSE

1^{st} Bid—Asking Price at MSRP/Dealer List Price for Purchase

-Lease payment based on Capital cost of MSRP/List

2^{nd} Bid—Your Bid is too low, please increase the amount of your next Bid

3^{rd} Bid—Your Bid is still below the Seller's expectation and requires a substantial increase

4^{th} Bid—Sorry that we are unable to meet your expectations today. Please try again later

During Price negotiations for a vehicle, the Asking Price will be presented in one of the following two formats:

1) Asking Price of vehicle only

2) Asking Price combined with additional product(s) or service(s) accompanied by special overall discount(s)

If the shopper chooses the 1^{st} format, negotiations will continue in this manner in the main screen area, while a smaller sub screen (area) will offer pricing in accordance with the 2^{nd} format. This will allow the shopper to randomly add, delete, or reconsider special offers by instantly switching formats rather than having to begin anew or retrace steps. The options (product(s) or service(s)) along with accompanying overall discount(s) added to the sub screen may be individually deleted or retrieved by the shopper as the process unfolds.

If the 2^{nd} format is chosen, the negotiation process will continue in this manner only (no sub screen). Each new Asking Price will see additional value items and accompanying overall discounts introduced and offered. These options (product(s) or service(s)) along with accompanying discount(s) may be individually deleted or retrieved by the shopper as the process unfolds.

The net pricing (with discount(s)) for additional items will reflect not just the immediate value (profit) of the item to the dealership, but more importantly where applicable, the added values to be derived from inherent return visits to the dealership.

Each successive Bid must be higher than the previous one

During negotiating sessions, all Bids and Asks are compared (in real time) with the highest price (benchmark) among all (Host) Bids held in or concurrently added to the Host Reservoir for the same vehicle. Negotiating Bids must exceed the highest price or will receive the response: “The Host Reservoir contains a Bid on this vehicle that exceeds yours. Please submit a higher Bid or select another vehicle for negotiating purposes.”

In addition, each negotiating session is constantly being compared in real time with all other ongoing sessions involving the same vehicle resulting in a live on-line auction setting with the highest priced Host entry acting as the minimum Price. Each Bid Price is compared with all the others in process with only the highest (or 1^{st} highest) proceeding normally, while the others are notified that: “The Price of another Bid in process exceeds yours. You can attempt to supplant it by submitting a higher Bid or pause here while that interaction plays out, you'll be notified immediately when it's finalized. Alternatively, you may select another vehicle for negotiation purposes”.

Bids below a fixed price will not be accepted for vehicles with fixed prices. Response: “Sorry, a fixed price exists for this vehicle. Please utilize the fixed-price function or select another vehicle for which to submit a Bid”.

Members such as Manufacturers, Dealers and After Market Suppliers will be empowered to individually design or select pre-designed templates that allow them to customize special offers or programs to differentiate their brands and encourage shopper participation and loyalty.

Dealers will individually set acceptable price levels for used vehicles (trade-ins) by make, model and/or other preferred criteria as a percentage (%) variance (+ or −) of the standard price in accordance with their individual needs.

The identity of the shopper remains anonymous until a conditional agreement is reached between the dealer/system and shopper.

The system will adjust—on the fly—the maximum number of offers (asking price) allowed each shopper—per vehicle per internet session—based on the following factors:

Inventory levels

Age of inventory

Sales volumes (representative period)

Average sale price (representative period)

Target achievement (representative period)

When a conditional agreement is reached, the status of the vehicle changes to ‘SOLD/PENDING’ and is temporarily unavailable for sale. The Bill-of-Sale is updated displaying the agreed upon figures for confirmation by the shopper. Upon confirmation, the purchaser is asked if he/she requires financing in order to finalize the purchase. If the response is “no”, the financing condition is removed and the deal is consummated. If the response from the purchaser is “yes”, or the proposal is a leasing arrangement, he/she is requested to complete the credit application presented and click on the ‘SUBMIT’ button. The application is immediately processed and the applicant notified of the credit decision within two minutes. An accepted credit application removes the financing condition and the deal is consummated. If for some reason the application is declined, the system will suspend and hold current the unfinished process for a specified period while instructing the shopper to contact the dealer in order to rectify the situation. The dealer will also be immediately alerted in order to resolve the bottleneck.

The shopper is then requested to provide the information required for the registration of the vehicle and the session is completed.

Should the purchaser require assistance at any stage during the process, a request will be made electronically at the Portal by him/her to a call center where the necessary assistance will be provided in a helpful, soft sell, low key manner, keeping in theme with the e-commerce model.

Dealers may choose to provide a delivery service for which the dealer may charge a fee to the buyer, the cost of which may be added to or included in the cost of the vehicle. The vehicle is then delivered to the buyer on the appointed day and at the appointed time, or the buyer attends at the dealership to take delivery.

As an incentive to customers, the system will randomly select a completed transaction—one vehicle—from each batch of transactions (number in batch to be determined) and provide a full rebate of the cost of the vehicle purchased, effectively giving away a vehicle to one customer in each predetermined batch. Each purchaser will be assigned a referral ID (for use by persons referred to the site) since each qualifying referral will entitle the purchaser to an additional entry in the aforementioned draw. In addition, members/customers will participate in a ‘Customer Loyalty program’ that will award points for each completed transaction to be used for purchases at participating dealerships as well as for vacation-related expenses.

50% of the net profit (before taxes) attributed to the system is to be assigned to a special fund to be used to alleviate ‘Hunger among People of The World’.

What I claim as my invention is this e-commerce model for use by the Automobile Industry for the sale of motor vehicles, parts, accessories and services as described in this specification:

1. To date, this model has not been recognized, established, discussed, prepared for presentation, created in software or other format, in its entirety, by any other party.
